(19) United States
(12) Patent Application Publication
(10) Pub. No.: US 2021/0392498 A1
(43) Pub. Date: Dec. 16, 2021

(54) METHODS, USER EQUIPMENT AND NETWORK NODE, FOR DETECTION OF COMMUNICATION WITH A NON-LEGITIMATE DEVICE

(71) Applicant: Telefonaktiebolaget LM Ericsson (gubl), Stockholm (SE)

(72) Inventors: Prajwol Kumar NAKARMI, SOLLENTUNA (SE); Christine JOST, LUND (SE); Vlasios TSIATSIS, SOLNA (SE)

(73) Assignee: Telefonaktiebolaget LM Ericsson (gubl), Stockholm (SE)

(21) Appl. No.: 17/288,223

(22) PCT Filed: Oct. 25, 2019
(86) PCT No.: PCT/SE2019/051053

§ 371 Date: Apr. 23, 2021

Related U.S. Application Data
(60) Provisional application No. 62/750,860, filed on Oct. 26, 2018.

(51) Int. Cl. H04W 12/122; H04W 36/14; H04W 4/14

(52) U.S. Cl. CPC H04W 12/122; H04W 4/14; H04W 36/14

(57) ABSTRACT

A User Equipment, UE, (120), a network node (110, 111, 140) and methods therein, for detection that the UE has been communicating with a non-legitimate device (150) which impersonates a network node of a legitimate network. In this method, the UE or the network node obtains information regarding technical details of the transmission of a service received by the UE, wherein the information comprises a generation of the RAT/mobile network used for the transmission. The UE then provides the technical details to a user of the UE and/or to an application on the UE. The network node is also able to determine that the service was received from the non-legitimate device when the technical details do not correspond to the technical details expected for the legitimate network.

### TECHNICAL FIELD

Embodiments herein relate to a User Equipment, UE, a network node and methods therein, for detection that the UE has been communicating with a non-legitimate device which impersonates a network node of a legitimate network.

### BACKGROUND

In a typical wireless communication network, wireless devices, also known as wireless communication devices, mobile stations, stations (STAs) and/or User Equipments (UEs), communicate via a Local Area Network such as a Wi-Fi network or a Radio Access Network (RAN) to one or more core networks (CNs). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node. The CN comprises several types of core network functions which are responsible for various functions such as handling mobility of the UE, interconnecting to data network, packet routing and forwarding, among other responsibilities.

FIG. 1 discloses a simplified wireless communication network. Wireless communication networks, which may also be referred to as Mobile networks, provide various services such as e.g. short message service (SMS), phone calls, and internet access to users wirelessly. There are currently several generations of mobile networks available, such as e.g. Second Generation (2G), Third Generation (3G), Fourth Generation (4G), and Fifth Generation (5G), 5G being the latest generation. The architecture, interfaces, protocols, procedures, and messages, as well as security aspects of these mobile networks are standardized by the 3rd Generation Partnership Project (3GPP).

Specifications for the Evolved Packet System (EPS), also called a 4G network, have been completed within the 3GPP and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE or gNBs in 5G, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

The mobile networks are typically operated, and their services are offered by so-called mobile network operators (MNOs). In order to use a particular mobile network offered by a particular MNO, users are required to have a contractual relationship with that MNO. Such a contractual relationship is generally called a subscription.

A commonly used business model could typically work as follows. The MNOs provide services to users that have a valid subscription. These users use services provided by the MNO, such as e.g. send short messages often referred to as SMS or text, make phone calls, and/or get internet access. The MNOs charge these users for the services they have used through the MNOs' billing or charging systems. The users pay according to the billed amount.

This business model is supported by several security features built into the mobile networks. For example, the network may authenticate the users and determine if they have valid subscriptions. The traffic belonging to services such as SMS, phone calls, and/or internet data, are transported in a secure way so that the users are billed correctly according to their usage of the traffic.

The traffic itself is generally of two types, including control plane (CP) traffic and user plane (UP) traffic. The control plane traffic is used for management of the traffic, and user plane traffic carries the actual data. The secure transport of the traffic is achieved by confidentiality/ciphering and integrity protection. Confidentiality/ciphering in this context means encryption of a communicated message, which makes it infeasible for unauthorized parties to decrypt and read the original message. Integrity protection in this context means that the sender adds a security token or a message authentication code (MAC) to the message that the receiver can verify, which makes it infeasible for unauthorized parties to tamper the original message without the receiver detecting the tampering.

Even with these security features, mobile networks are not free from different types of fraudulent attacks. Existing frauds often cause financial harm to the MNOs or to the users. Financial harm to the users are mainly caused by fraudsters tricking the users into using a service that brings a substantial share of the billed amount to the fraudsters. The users end up paying the billed amount even though they did not intend to use the services in the first place.

FIG. 2 discloses an example of how a false base station attack may occur. One of several tools at the disposal of fraudsters, is the so-called false base station which is a general name for a device that impersonate a genuine base station of a legitimate mobile network controlled by the user's MNO, and that are used to eavesdrop over-the-air traffic and track mobile users. The false base station will be referred to herein as a non-legitimate device. The capabilities of false base stations vary depending upon whether the genuine mobile network is 2G, 3G, 4G or 5G.

The 3G, 4G, and 5G mobile networks are resilient to several types of attacks from false base stations that 2G networks were susceptible to. In 2G mobile networks, false base stations can in principle impersonate a complete network and perform various activities and services, such as e.g. sending spam or advertisement SMS and calls to UEs. Users of the UEs may reply with SMS or call back. This may result in expensive billing to those users because the termination number of those replied SMSs or calls may belong to an expensive value-added service number. Ultimately, the users that are victims to such false base stations may lose money or time trying to reclaim their money.

It is desirable but challenging to prevent victims from getting billed for the services that they were tricked into using by false base stations, which may herein also be referred to as false services.

### SUMMARY

It is an object of embodiments described herein to address at least some of the problems and issues outlined above. It is possible to achieve this object and others by using a User Equipment, UE, a network node and methods therein, as defined in the attached independent claims.

According to one aspect, a method is performed by a user equipment, UE, in a communications network, for detection that the UE has been communicating with a non-legitimate device which impersonates a network node of a legitimate network. In this method, the UE obtains information regarding technical details of the transmission of a service received by the UE, wherein the information comprises a generation of the Radio Access Technology, RAT/mobile network used for the transmission. The UE also provides the technical details to a user of the UE and/or to an application on the UE. Such technical details may reveal that the service was transmitted in a way that is not expected from a legitimate network node, such as when the service was transmitted using 2G technology while a legitimate network node is expected to communicate with 3G or later generation technology. The information regarding technical details may be displayed visible on the UE to the user, and/or may be provided to an application which may use the information as a basis to block any responding call or message from the UE to the non-legitimate device.

According to another aspect, a UE is arranged for detection that the UE has been communicating with a non-legitimate device which impersonates a network node of a legitimate network. The UE is configured to obtain information regarding technical details of the transmission of a service received by the UE, wherein the information comprises a generation of the RAT/mobile network used for the transmission. The UE is also configured to provide the technical details to a user of the UE and/or to an application on the UE.

According to another aspect, a method is performed by a network node in a communications network, for detection that a UE has been communicating with a non-legitimate device which impersonates a network node of a legitimate network. In this method, the network node obtains information regarding technical details of the transmission of a service received by the UE, wherein the information comprises a generation of the RAT/mobile network used for the transmission of the service to the UE. the network node further determines, based on the received information, that the service was received from the non-legitimate device, wherein the service is determined to have been received from the non-legitimate device when the technical details do not correspond to the technical details expected for the legitimate network.

According to another aspect, a network node in a communications network, is arranged for detection that a UE has been communicating with a non-legitimate device which impersonates a network node of a legitimate network. The network node is configured to obtain information regarding technical details of the transmission of a service received by the UE, wherein the information comprises a generation of the RAT/mobile network used for the transmission of the service to the UE. The network node is also configured to determine, based on the received information, that the service was received from the non-legitimate device, wherein the service is determined to have been received from the non-legitimate device when the technical details do not correspond to the technical details expected for the legitimate network.

The above UE, network node and methods have the advantage of enabling more efficient and reliable detection of fraudulent communication from a non-legitimate device, and to warn the user of the UE, or to notify an application therein, from calling back to a missed telephone number which could otherwise result in extra costs, e.g. if the missed number is related to a premium service or the like associated with a high calling fee.

The above UE, network node and methods may be configured and implemented according to different optional embodiments to accomplish further features and benefits, to be described below.

A computer program is also provided comprising instructions which, when executed on at least one processor in the above UE or network node, cause the at least one processor to carry out either of the methods described above. A carrier is also provided which contains the above computer program, wherein the carrier is one of an electronic signal, an optical signal, a radio signal, or a computer readable storage medium.

### BRIEF DESCRIPTION OF THE DRAWINGS

Examples of how embodiments herein could be employed are described in more detail with reference to attached drawings in which:

FIG. 1 is a schematic block diagram illustrating a simplified example of a wireless communications network.

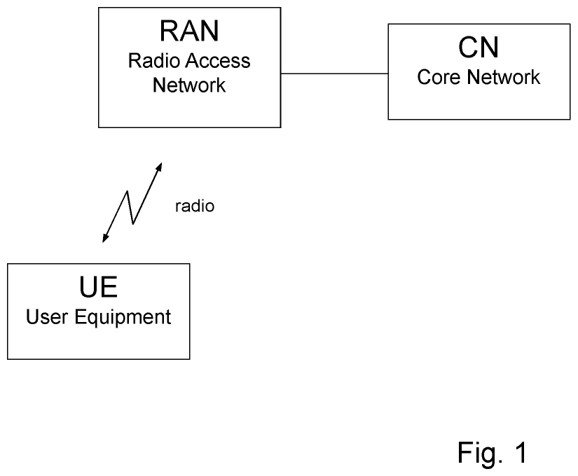

FIG. 2 is a schematic block diagram illustrating how a false base station attack could occur in a wireless communications network.

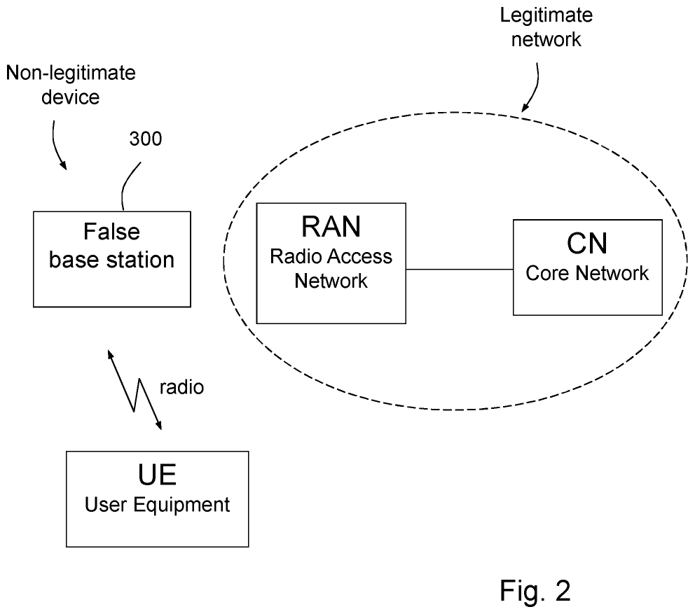

FIG. 3 is a schematic block diagram illustrating an example of a wireless communications network where the embodiments herein may be used.

FIG. 4 is a flow chart illustrating a method performed by a UE, according to some embodiments.

FIG. 5 is a schematic diagram illustrating how technical details of a received service may be indicated, according to further embodiments.

FIG. 6 is a schematic diagram illustrating some further examples of indicating technical details of a received service, according to further embodiments.

FIG. 7 is a schematic diagram illustrating some further examples of indicating technical details of received services, according to further embodiments.

FIG. 8 is a schematic diagram illustrating another example of indicating technical details of a received service, according to further embodiments.

FIG. 9 is a schematic diagram illustrating some further ways of indicating technical details in a history of received SMS services according to further embodiments.

FIG. 10 is a schematic diagram illustrating some further examples of indicating technical details of received services according to embodiments.

FIG. 11 is a flow chart illustrating a method performed by a network node, according to further embodiments.

FIG. 12 is a schematic block diagram illustrating a UE according to some embodiments.

FIG. 13 is a schematic block diagram illustrating the UE according to some further embodiments.

FIG. 14 is a schematic block diagram illustrating a network node according to some embodiments.

FIG. 15 is a schematic block diagram illustrating the network node according to some further embodiments.

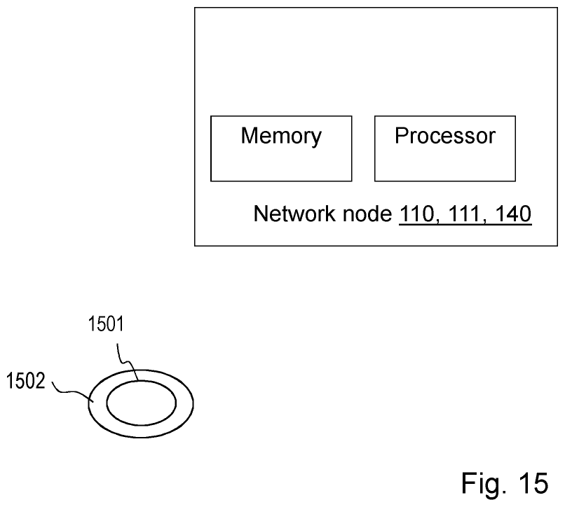

FIG. 16 is a schematic block diagram illustrating a UE arranged for obtaining technical details of a received service.

FIG. 17 is a schematic block diagram illustrating the UE according to some further embodiments herein for obtaining technical details of the received service.

### DETAILED DESCRIPTION

The embodiments disclosed herein are directed to a solution where technical details regarding the transmission of a service to a UE are provided in order to enable detection of communication with a non-legitimate device, such as e.g. a false base station, which impersonates a network node of a legitimate network. The technical details may be provided to a user of the UE and/or to an application on the UE so that the user and/or application is able to decide whether a communicating device is legitimate or not, based on the provided technical details. More specifically, the technical details may e.g. comprise the type of mobile network technology used for the communication, such as e.g. 2G, 3G, 4G, 5G, and/or configuration parameters used for the communication, such as confidentiality/ciphering used, integrity protection used, ciphering algorithm used etc.

The embodiments herein also enable a sanity check of services. The sanity check shall herein be interpreted as the UE providing information regarding the technical details of the service received to a network node of a legitimate network such as a mobile network in which the user is a subscriber. The network node may, based on the received information from the UE, determine whether the information regarding the technical details correspond to the expected technical details of the legitimate network or not. If the network node determines that the information regarding the technical details does not correspond to the expected technical details, the network node may indicate to the UE that the service may have been received from a potentially fraudulent device, which is referred to herein as a non-legitimate device.

The embodiments herein may maintain a history of service usage timestamped and potentially location stamped, and this history may be used as a basis for determining whether a current communication of a service can be regarded as expected or not. For example, if any technical details regarding the service transmission deviate significantly from what can be expected according to the maintained service usage history, the device transmitting the service can be regarded as potentially non-legitimate. Some examples of such service usage that may be maintained as service usage history are listed below:
1. An SMS may have been sent by using a specific Protocol Data Unit (PDU) connection with a set of characteristics, such as e.g. a 3G network with null ciphering or a 2G fallback network while there existed other more secure networks for the UE to connect to in the vicinity, but with less transmission power. The characteristics may herein also be referred to as technical details of the received service.
2. A web page access may have initiated 3 different PDU connections in 3 different points in time with 3 different characteristics.

In these cases, the storage of the history of service usage in the UE enables the UE, such as e.g. an application running on the UE, to present to a user of the UE an assessment of the existence of non-legitimate devices or false base stations in a certain area. The UE or an anti-virus applications running on the UE may also provide recommendations to the user of the UE about the legitimacy of certain data, such as e.g. of the SMS from false base stations as presented earlier. Moreover, the UE may be a one-stop node with standardized Application Program Interfaces (APIs) on a UE for vouching about the trustworthiness of the underlying communication based on the said characteristics. This could be a useful node for autonomous or “headless” UEs such as IoT devices for enabling automatic UE decisions based on a security policy set by the operator of the IoT deployment.

The embodiments herein may be used to solve the above mentioned problems by providing a lightweight, effective and flexible solution for detecting non-legitimate devices or false base stations that trick users into using unintended services, such as e.g. false and/or fraudulent services.

The lightweight-ness in the embodiments disclosed herein comes from the fact that there is no major impact on hardware, if any at all, both at network and UE side. Furthermore, the impact on signaling between the UE and the network is also minimal, if any.

Said effectiveness in the embodiments disclosed herein comes from the fact that false services tricked by non-legitimate devices or false base stations can be easily detected.

The flexibility in the embodiments disclosed herein comes from the fact that the false services tricked by non-legitimate devices or false base stations can be detected either automatically by UEs without human interaction, or by users of UEs, or by the network—depending upon how the embodiments herein are implemented.

In some embodiments herein, the general term “network node” is used and it may correspond to any type of radio network node or any network node which communicates with at least a radio network node. Examples of network nodes are any radio network node stated above; a core network node, such as e.g. a Mobile Switching Centre (MSC), a Mobility Management Entity (MME), an Operations & Management (O&M) node, an Operation, Administration and Maintenance (OAM) node, an Operations Support Systems (OSS) node, a Self-Organizing Network (SON) node, a positioning node, such as e.g. an Enhanced Serving Mobile Location Centre (E-SMLC), or a function related Minimization of Drive Tests (MDT) etc.

In some embodiments the non-limiting term “network device” is used and it refers to any type of wireless device communicating with a network node in a cellular or mobile communication system and being able to perform measurements on other network nodes in a surrounding or tracking area of the network device. Examples of a network device are UE, mobile terminal, target device, device to device UE, machine type UE or UE capable of machine to machine communication, PDA, iPAD, Tablet, mobile terminals, smart phone, Laptop Embedded Equipment (LEE), Laptop Mounted Equipment (LME), USB dongles, radio network node, radio access node etc.

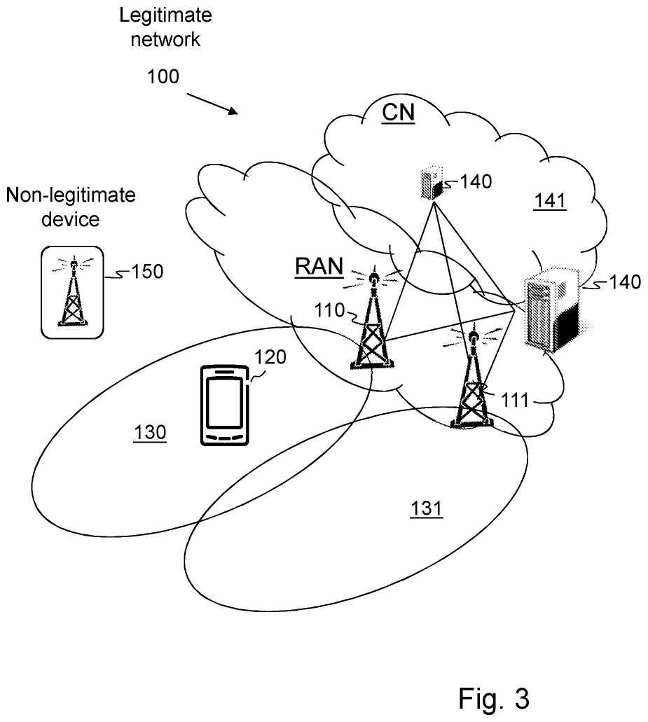

FIG. 3 depicts an example of a communications network 100 according to a first scenario in which embodiments herein may be implemented. The communications network 100 is a wireless communication network such as e.g. an LTE, E-Utran, WCDMA, GSM network, any 3GPP cellular network, Wimax, or any cellular network or system.

The communications network 100 comprises a Radio Access Network (RAN) and a Core Network (CN). The communication network 100 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. In the communication network 100, one or more UEs 120 may communicate via one or more Access Networks (AN), e.g. RAN, to one or more CNs. The UE 120 may e.g. be a wireless device (WD), a mobile station, a non-access point (non-AP) STA, a STA, and/or a wireless terminal. It should be understood by those skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a base station communicating within a cell.

The RAN comprises a set of radio network nodes, such as radio network nodes 110, 111 each providing radio coverage over one or more geographical areas, such as a cell 130, 131 of a radio access technology (RAT), such as LTE, UMTS, Wi-Fi or similar. The radio network node 110, 111 may be a radio access network node such as radio network controller or an access point such as a wireless local area network (WLAN) access point or an Access Point Station (AP STA), an access controller, a base station, e.g. a radio base station such as a NodeB, an evolved Node B (eNB, eNodeB), a base transceiver station, Access Point Base Station, base station router, a transmission arrangement of a radio base station, a stand-alone access point or any other network unit capable of serving a wireless device within the cell, which may also be referred to as a service area, served by the radio network node 110, 111 depending e.g. on the first radio access technology and terminology used.

The CN further comprises a core network node 140 which is configured to communicate with the radio network nodes 110, 111, via e.g. an S1 interface. The core network node may e.g. be a Mobile Switching Centre (MSC), a Mobility Management Entity (MME), an Operations & Management (O&M) node, an Operation, Administration and Maintenance (OAM) node, an Operations Support Systems (OSS) node and/or a Self-Organizing Network (SON) node. The core network node 140 may further be a distributed node comprised in a cloud 141.

The UE 120 is located in the cell 130 of the network node 110, which is referred to as the serving cell, whereas the cell 131 of the network node 111 is referred to as a neighboring cell. Although, the network node 110 in FIG. 3 is only depicted providing a serving cell 130, the network node 110 may further provide one or more neighboring cells 131 to the serving cell 130.

The communications network 100 may further comprise a non-legitimate device 150. The radio network nodes 110, 111 and the core network node may all be associated with a first domain of the communications network 100. The first domain is a part of the network which is operated by a provider with which a user or a UE 120 has a service agreement, i.e. the first domain can be seen as a legitimate network in this context. Network nodes operated by a roaming partner of the provider are also associated with the first domain. The first domain of the communications network 100 may herein also be referred to as the legitimate network. The non-legitimate device 150 is a device which can be regarded as being associated with a second domain of the communications network 100, i.e. a domain not operated by the provider or a roaming partner. The non-legitimate device 150 impersonates a network node 110, 111, 140 of the first domain of the communications network 100 in order to try to lure the UE 120 to connect to the device. The second domain of the communications network 100 may herein be referred to as a non-legitimate network.

The UE 120 may further be configured to communicate over a plurality of different RATs, such as LTE, UMTS, Wi-Fi or similar.

Note that although terminology from 3GPP LTE has been used in this disclosure to exemplify the embodiments herein, this should not be seen as limiting the scope of the embodiments herein to only the aforementioned system. Other wireless systems, including WCDMA, WiMax, UMB, GSM network, any 3GPP cellular network or any cellular network or system, may also benefit from exploiting the ideas covered within this disclosure.

Also note that terminology such as network node and network device should be considering non-limiting and does in particular not imply a certain hierarchical relation between the two; in general “network node” may be considered as a first device, or device 1, and “network device” may be considered as a second device, or device 2, and these two devices may communicate with each other over a radio channel. The embodiments herein further focus on wireless transmissions in the downlink, however the embodiments herein could also be applicable in the uplink.

As mentioned above, preventing users from getting billed for services (false services) that they were tricked into using by false base stations, i.e. non-legitimate devices, is extremely difficult. In other words, it is very challenging to prevent users from using the false services, such as e.g., preventing users from replying to some SMS message or from calling back to some phone number.

One known technique may be that the user always calls his MNO's customer service in order to validate whether the received SMS and/or call is genuine or not, meaning if they originated from the MNO or not. While this technique works well in theory, it is impractical and costly for the MNO because the number of users for a MNO may range from hundreds of thousands to millions. Furthermore, this solution is inconvenient for the user, since it requires an extra action every time an SMS or a call is received.

Another known technique may be that the UE rejects services, such as SMS or calls, which are received with null-ciphering. Null-ciphering herein means that no encryption is applied to the traffic. False base stations i.e. non-legitimate devices need to use null-ciphering when transmitting a service to a UE since they do not have the encryption keys derived from the secret key shared by the UE and the genuine mobile network, which secret key is used as a basis for most of the security mechanisms between the UE and the mobile network. In 3G, 4G, and 5G mobile networks, in addition to the network authenticating the UE, the UE also authenticates the network. Hence, a non-legitimate device cannot deliver false SMS or calls over-the-air in a 3G, 4G and/or 5G network. An attacker would therefore lure the UE to connect to a 2G-based non-legitimate device and then commands the UE to use null-ciphering. After that, the attacker may send false SMS or calls to the UE. Hence, rejecting services received with null-ciphering might be an option for preventing the user from being falsely billed. However, this might also hamper some genuine services from legitimate devices using null-ciphering, since null-ciphering is also allowed in 3G, 4G and 5G mobile networks for various reasons, such as e.g. testing, regulatory obligations, etc.

Yet another known technique could be that the UE displays a null-ciphering indicator during the service, such as for the SMS or for the call. For example, 3GPP TS 33.501 v. 15.2.0 mentions about security visibility in Clause 5.10.1 that UEs shall provide visibility of the information like confidentiality/ciphering, integrity, algorithm, bearer information to the applications in the UE, e.g. via APIs. The TS 33.501 v. 15.2.0 mentions that this information is provided by the UE to the applications for certain events and according to the users or application's concern. Furthermore, according to TS 33.501 v. 15.2.0, the UE shall provide such security information on a per protocol data unit (PDU) session granularity. The PDU session is an association between the UE and a data network that provides a data connectivity service.

Such display of null-ciphering might provide some guidance to the users that their UEs might be connected to a false base station or non-legitimate device. However, such a null-ciphering indicator does not always help. Firstly, as mentioned previously, null-ciphering is also allowed in genuine 3G, 4G, and 5G mobile networks. Secondly, the user might miss the indication, e.g., while actually making the call, or the user might never see the indication, e.g., because the indication would go away after the SMS has been delivered. Thirdly, security information may change when the PDU session changes, meaning that an earlier PDU session when the service was received could have different security properties, such as e.g. the ciphering algorithm, than a later PDU session.

In the following section, the embodiments herein will be illustrated in more detail by a number of exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

The fundamental idea of the embodiments herein is to use the technical details of how the service was received by the UE during and also after the service was used in order to enable detection of a potentially fraudulent service. The embodiments herein also enable a sanity check to be performed by the network. Such details would be immensely helpful to users so that they can detect a non-legitimate device based on those details.

It should be appreciated that the following description and examples are helpful for person skilled in the art to get the understanding of the invention and are not limiting. For example, some actions may be taken by the UE itself or by a user of the UE; an example described for an SMS would equally apply to a call or to other types of services, etc.

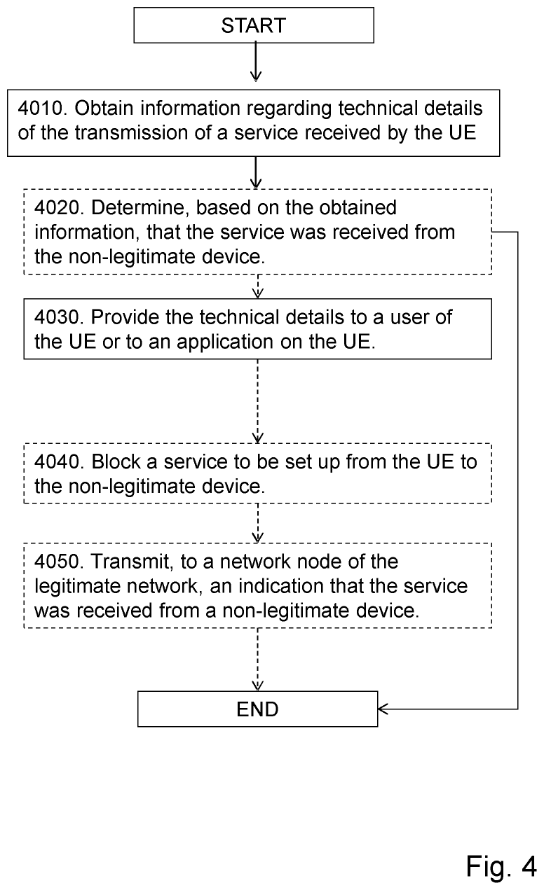

Example embodiments of the method performed by the UE 120 in the communications network 100, in a communications network 100, for detection that the UE 120 has been communicating with a non-legitimate device 150 which impersonates a network node of a legitimate network, will now be described with reference to a flowchart depicted in FIG. 4. The UE 120 can be regarded as being associated with a first domain of the communications network 100. The non-legitimate device 150 can further be regarded as a device that is associated with a second domain of the communications network 100, which device impersonates a network node 110, 111, 140 of the first domain of the communications network 100.

The method may comprise the following actions, which actions may be taken in any suitable order. Dashed lines of a box in FIG. 4 indicate that this action is not mandatory.

### Action 4010

The UE 120 obtains information regarding technical details of the transmission of a service received by the UE 120. The information comprises a generation of the RAT and/or the mobile network used for the transmission.

The UE 120 may e.g. obtain the information from a Terminal Equipment (TE) comprised in the UE 120. The technical details may e.g. be a generation of mobile networks, a security algorithm, a location, of how the service was delivered.

### Action 4020

The UE 120 may determine, based on the obtained information, that the service was received from the non-legitimate device 150.

The UE 120 may determine the service to have been received from the non-legitimate device 150 when the service was received via a second generation (2G) mobile network although later generation mobile networks are expected.

The UE 120 may further determine the service to have been received from the non-legitimate device 150 when the UE 120 uses a newer generation network and the UE 120 switches to a 2G mobile network for a short period of time and receives the service during the period of time that the UE 120 is connected to the 2G network.

### Action 4030

The UE 120 indicates or provides the technical details to a user of the UE 120 and/or to an application on the UE.

If the UE 120 has determined in action 4020 that the service was received from a non-legitimate device, the UE 120 may in action 4030 indicate, e.g. to the user of the UE 120, that the service was received from the non-legitimate device 150.

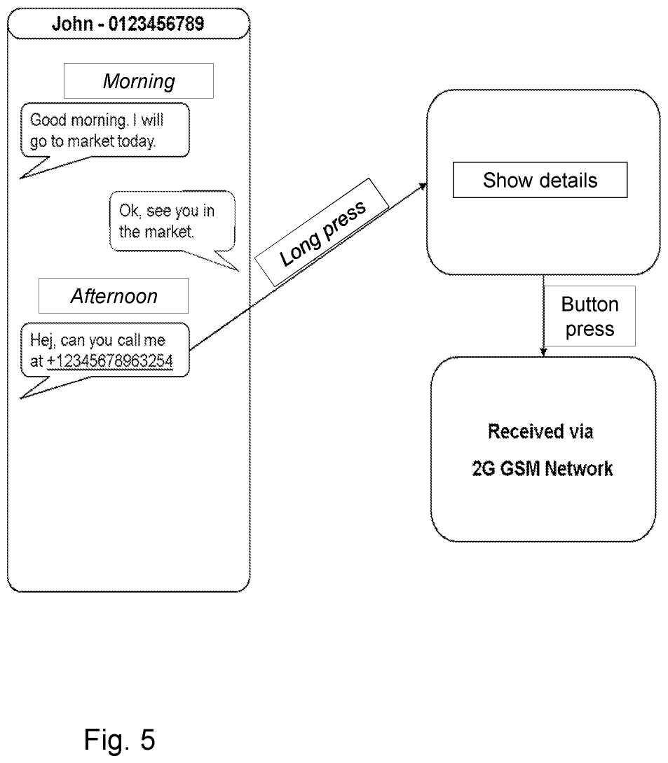

Examples of how the generation of the RAT could be indicated are described in relation to FIGS. 5 to 10.

### Action 4040

The UE 120 may block a service to be set up from the UE 120 to the non-legitimate device 150 below.

For example, if the user tries to call or text back to a missed number, the UE 120 may in this case not transmit the call or text and may instead display a notification indicating that the number that the user tries to call or text may be related to a non-legitimate device or may be fraudulent. The UE 120 may also provide the option of allowing the user of the UE 120 to accept that the call to the missed number may be a call to a non-legitimate device in order to allow the blocked call to be transmitted. This may e.g. be beneficial if the UE 120 wrongfully blocks a number which the user of the UE 120 can identify and recognize as being a legitimate number.

In some embodiments, the UE 120 or an application in the UE 120 may block the call from being made to the non-legitimate device by e.g. removing the suspected fraudulent calls from notification, or by showing the notification only when the service is received via a RAT generation later than a certain threshold, such as e.g. 3G or later. The action may be configured as default by a manufacturer of the UE 120 or by an app developer, or by configuration from the user.

In some further embodiments, a call may be marked as fraudulent and may be stored by the UE 120 or an app in the UE 120 in order to block such calls in the future and also to inform the corresponding network service for further fraud analysis corresponding prevention measures. The user may e.g. mark a certain number as fraudulent and the UE may store the number marked by the user and may, based on these stored numbers, block incoming calls from and/or outgoing calls to the stored numbers.

### Action 4050

The UE 120 may further transmit, to a network node 110 of the legitimate network, e.g. the aforementioned first domain of the communications network 100, an indication that the service was received by a non-legitimate device 150. The indication may be used by the network node 110 to take various actions such as e.g. triggering an alarm in e.g. a network operation center. Triggering the alarm may raise an alert level. The network node 110 may, based on the indication received from the UE 120, raise a warning message providing an alert on a possible presence of a non-legitimate device, such as e.g. a false or rogue base station, in the area, which may be sent to the UE 120 or to a second receiver, such as e.g. the network provider and/or the police. The alerting may e.g. be performed via email and/or SMS. Once the false base stations or non-legitimate devices are detected, they may be reported to the authorities, located, e.g., via triangulation, and removed.

An exemplary SMS conversation is illustrated in FIG. 5 which shows how different information may be indicated on the UE 120. When the UE 120 receives an SMS asking the user of the UE 120 to call a foreign number, the user would probably do so if the contact is trusted. However, such an SMS may have been received from a non-legitimate device. The UE may have been using a 4G network. Then, an attacker, such as e.g. an operator of the non-legitimate device, may have lured the UE 120 to connect to its own false 2G mobile network for a short period of time, and may then have delivered the SMS to the UE 120, and may then have sent the UE back to the original 4G network. According to the embodiments herein the user may make a more qualified decision whether to trust the SMS or not by having a possibility to look at the details of how the SMS was received. In the example of FIG. 5, the user may long press the particular SMS and find out the details about how the SMS was delivered, in this case that it was delivered by a 2G GSM Network. Thereby, the user may suspect a false base station or non-legitimate device, and may call the sender's (John in this example) local number instead.

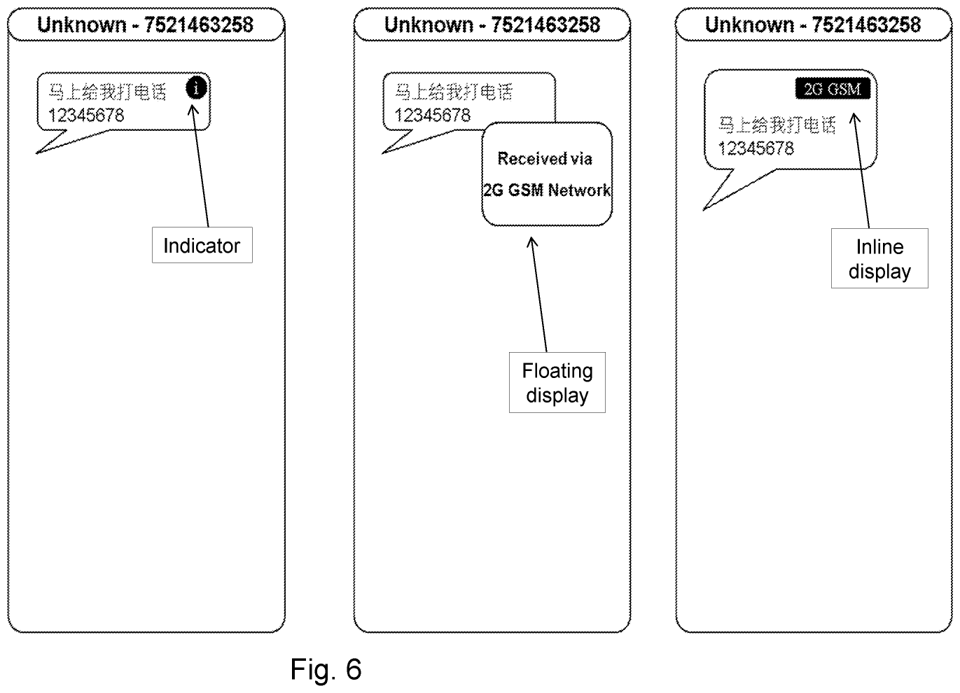

Other examples of how information could be indicated on the UE 120 in connection with SMS interactions are shown in FIG. 6. A user who is travelling to a foreign country, may suddenly receive an SMS in a foreign language to the UE. The user may have the urge to call that number or reply back with an SMS because the user might think that message may have come from a hotel, or some other contextual reasoning like from a taxi service that the user has called before, etc. The exposure of details in the leftmost example is a small indicator that the user can click to receive the details of how the SMS or call was received. The middle example shows the information being presented as a floating display, and the rightmost example shows the information being presented in an inline display in the SMS message.

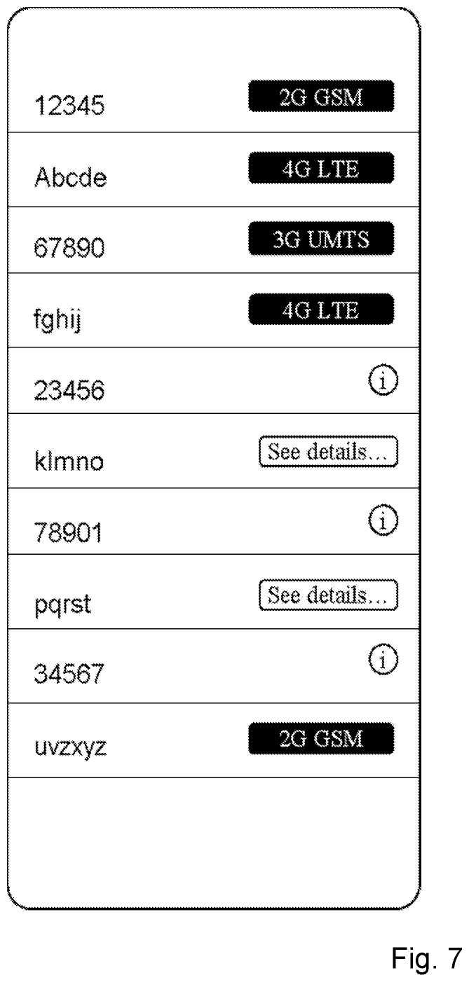

According to a further embodiment, the information regarding how a call was received may be presented in a call history of the UE 120 as shown in FIG. 7 which shows how the information related to a history of previously received calls may be indicated on the UE 120. One option may be to display texts like “4G LTE”, “3G UMTS”, “2G GSM” in relation to each call. Another option is to display an icon (“i” as shown) or a button (“See details . . . ” as shown) which the user can click on to display the details of a particular call. It should be appreciated that the display similar to FIG. 7 may also be provided for the SMS history.

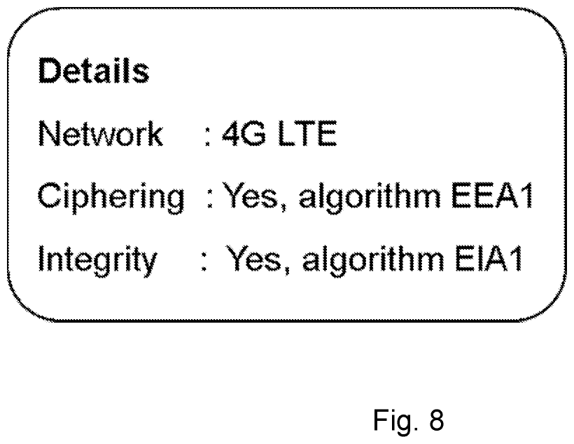

In the examples above, the detail display may in addition include other technical details, such as e.g., whether confidentiality/ciphering protection was applied or not, whether integrity protection was applied or not, which ciphering algorithm was used, which integrity protection algorithm was used, etc. An example of how such technical details of a received service may be indicated on the UE 120 is shown in FIG. 8. As can be seen in FIG. 8, this particular service, such as a call or an SMS, was received via a 4G LTE connection, with active ciphering using an EEA1 algorithm and active integrity using an EIA1 algorithm.

According to the embodiments herein, the technical details relating to the received service may also comprise location information indicating where the UE was located when the service was received. For example, the details for the SMS may also include the GPS location of the UE where the SMS was received.

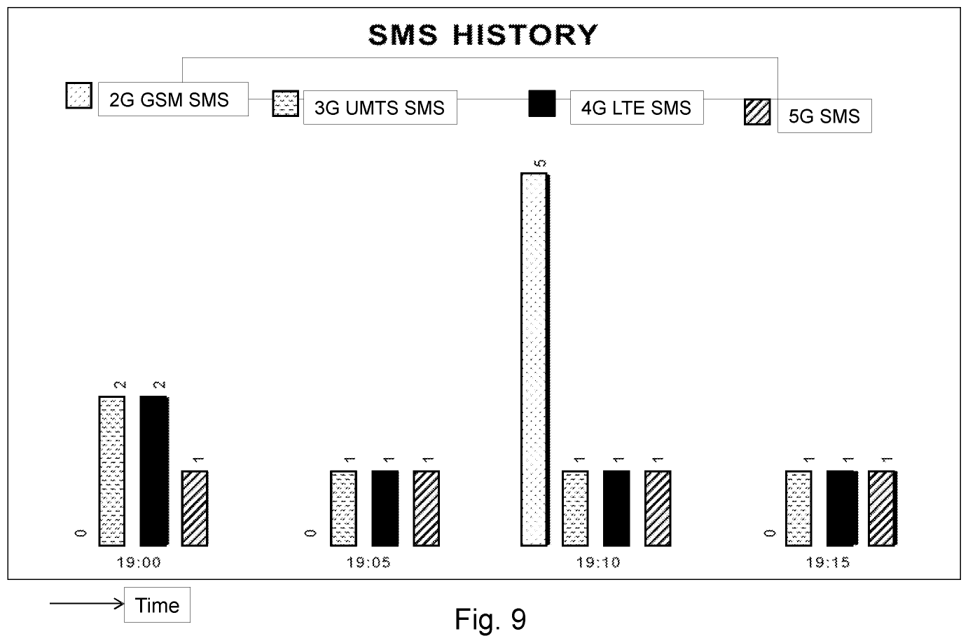

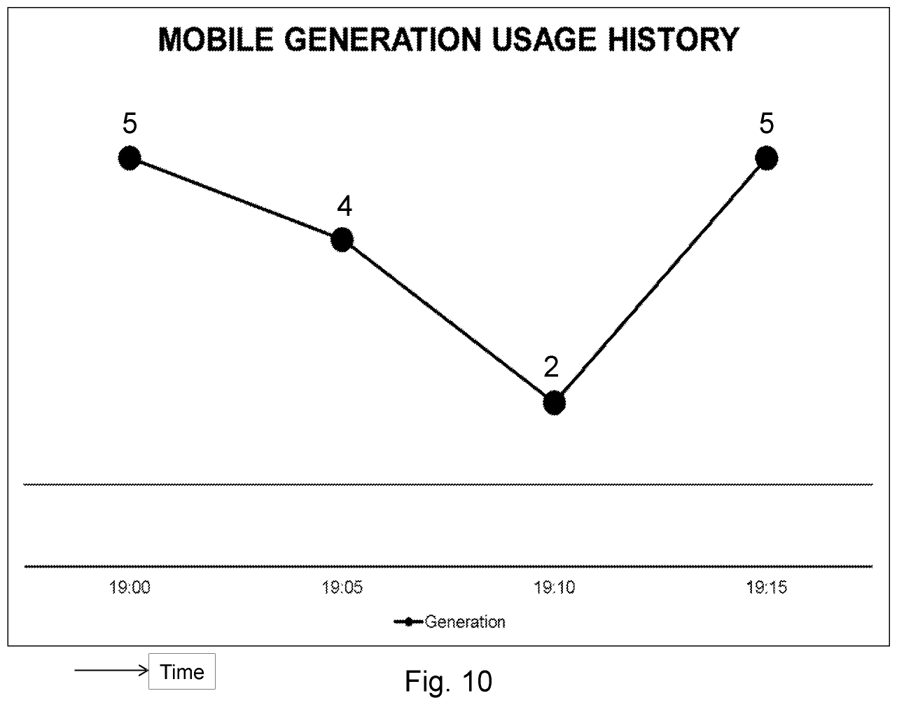

The embodiments herein also provide the possibility to indicate the history of different generations of mobile networks that the UE has been connected to, and other corresponding details like the number of SMS or calls received or made at that time, algorithms used at that time, etc. FIGS. 9 and 10 illustrate some examples. The X-axis of the shown diagrams represents time in both the FIGS. 9 and 10. FIG. 9 shows the number of SMS received using the different network generations at different times 19:00, 19:05, 19:10 and 19:15. As can be seen, at 19:00 five SMSs were received, wherein two were received using 3G, two were received using 4G and one was received using 5G, at 19:05 and at 19:15 three SMSs were received using 3G, 4G and 5G. However at 19:10 there was an increase in received SMSs, a total amount of eight SMSs were received, wherein five of these were received using 2G. Since the UE 120 typically uses 3G or newer generation network to receive the SMSs, the sudden increase of SMSs received via 2G networks may be an indication of a false base station or non-legitimate device attack.

FIG. 10 shows the generation of the mobile network used for services received at different times 19:00, 19:05, 19:10 and 19:15. As can be seen, at 19:00 5G was used for receiving the service, at 19:05 4G was used, at 19:10 the generation of the network suddenly dropped from 4G to 2G before it at 19:15 return to a 5G connection. The sudden drop of network generation at 19:10 may be an indication of a false base station or non-legitimate device attack.

In the following, some further examples of a UE and network interaction are described, which may further mitigate the risk of users falling victim to a fraud, such as a false base station or non-legitimate device attack. According to some embodiments, the network may configure the UE to report a summary of the received services, such as e.g. SMS and/or calls, and the technical details relating to the received services. The technical details relating to the services may be type of mobile network technology, such as the generation of the RAT, e.g. 2G, 3G, 4G, 5G, and/or configuration parameters, such as confidentiality/ciphering used, integrity protection used, ciphering algorithm used etc. The UE 120 may send this summary to the network. The network 100, such as e.g. a base station 110, may, based on the received summary, check if the services reported by the UE actually match the network's expected data. If the reported services don't match the expected data, the network may determine that a possible fraud may have been conducted by a false base station or non-legitimate device. Hence, the network may perform a sanity check of the network.

Similarly, when the user of the UE 120, or the UE 120 itself, e.g. by means of a learning algorithm or rule in the UE, determines that a service looks suspicious, such as e.g. when a known user, such as e.g. sends an SMS and asks to call a foreign number, the UE 120 may send a summary about the received services comprising details about the service, to the network. This may be triggered by the user of the UE 120 or may be sent by the UE upon detection of a suspicious service. The network may check if the services reported by the UE actually match the network's expected data. If they don't match then it could be inferred that there was possibly a fraud conducted by a non-legitimate device or false base station. Hence, the network may perform a sanity check of the network. This is similar to action 1120 described below. In this case, if the UE 120, e.g. by means of a learning algorithm or rule in the UE, determines that a service is deemed suspicious, the UE 120 may also alert the user of the UE 120, e.g., by displaying a warning pop-up or the like.

Furthermore, the location information where the UEs received false services may be used to identify a problematic area, e.g. an area where a non-legitimate device or false base station may be located.

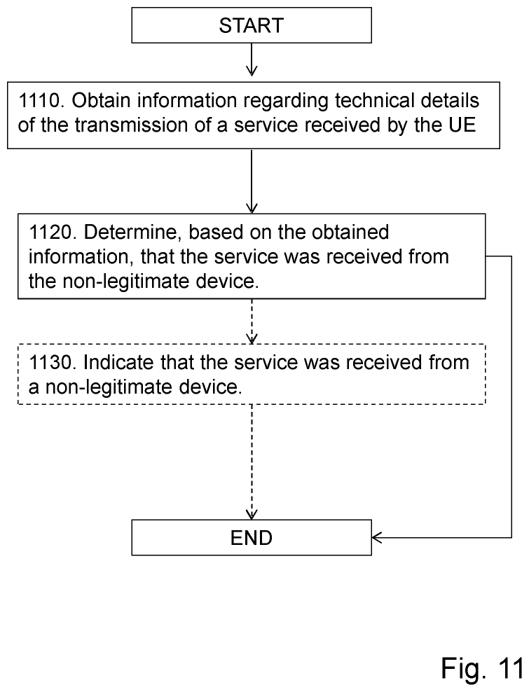

The network may then perform some actions, such as informing the user, authorities and/or service personnel, e.g., by sending an SMS or an email, or trying to locate and neutralize or counteract the false base station or non-legitimate device. Example embodiments of a method performed by the network node 110, 111, 140 in the communications network 100, for enabling detection that the UE 120 has been communicating with a non-legitimate device 150 which impersonates a network node of a legitimate network, will now be described with reference to a flowchart depicted in FIG. 11. As mentioned above, the UE 120 may be associated with a first domain of the communications network 100 and the non-legitimate device 150 may be associated with a second domain of the communications network 100, which device impersonates the network node 110, 111, 140 of the first domain of the communications network 100.

The method may comprise the following actions, which actions may be taken in any suitable order. Dashed lines of a box in FIG. 11 indicate that this action is not mandatory.

### Action 1110

The network node 110, 111, 140 obtains information regarding technical details of the transmission of a service received by the UE 120. The information comprises a generation of the RAT and/or the mobile network used for the transmission.

The technical details may e.g. be a generation of mobile networks, a security algorithm, and/or a location, of how the service was delivered.

The network node 110, 111, 140 may further receive, from the UE 120, an indication that the service was received from a non-legitimate device 150.

### Action 1120

The network node 110, 111, 140 determines, based on the received information, that the service was received from the non-legitimate device 150. The network node 110, 111, 140 may determine the service to have been received from the non-legitimate device when the technical details do not correspond to the technical details expected for the legitimate network.

The network node 110, 111, 140 may determine the service to have been received from the non-legitimate device 150 when the information regarding the technical details show that the service was received via a second generation (2G) mobile network although later generation mobile networks are expected.

### Action 1130

The network node 110, 111, 140 may indicate that the service was received from the non-legitimate device 150.

The network may indicate that the service was received from the non-legitimate device by performing some actions, such as e.g. informing the user, authorities and/or service personnel, e.g., by sending an SMS or an email, or trying to locate and neutralize the non-legitimate device. Locating and neutralizing the non-legitimate device may e.g. be performed based on information such as e.g. the location of the UE 120 when the service was received.

The network node 110 may take various actions such as e.g. triggering an alarm in e.g. a network operation center, based on the determination or the received indication that the service was received from the non-legitimate device. Triggering the alarm may raise an alert level. The network node 110 may raise a warning message providing an alert on a possible presence of a non-legitimate device 150, such as e.g. a false or rogue base station, in the area, which may be sent to the UE 120 or to a second receiver, such as e.g. the network provider and/or the police. The alerting may e.g. be performed via email and/or SMS. Once the false base stations or non-legitimate devices are detected, they may be reported to the authorities, located, e.g., via triangulation, and removed or otherwise deactivated.

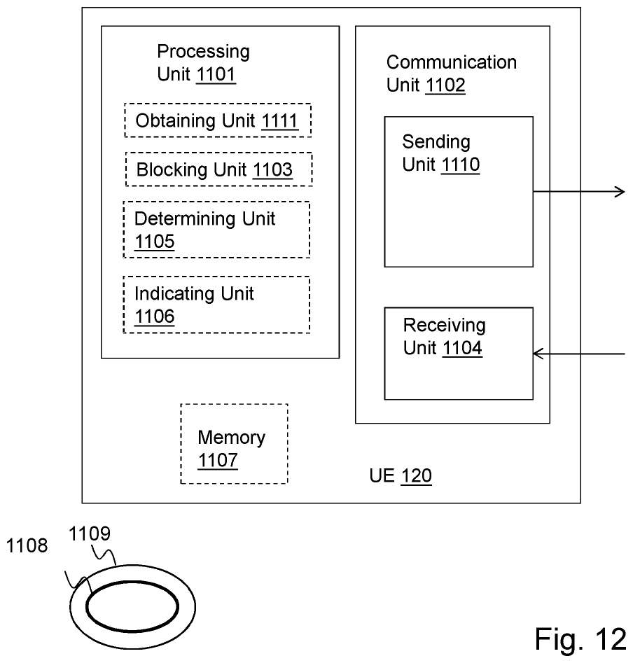

To perform the method actions for detection that the UE 120 has been communicating with a non-legitimate device 150, described above in relation to FIG. 4, the UE 120 may comprise the following arrangement as depicted in FIG. 12.

The UE 120 may comprise a processing unit 1101 and a communication unit 1102 for communicating with network devices, such as network nodes 110, 111, 140 or other UEs. The communication unit 1102 may comprise a sending unit 1110 and a receiving unit 1104.

The UE 120 may be configured to, e.g. by means of the communication unit 1102 and/or an obtaining unit 1111 and/or the processing unit 1101, obtain information regarding technical details of the transmission of a service received by the UE 120, wherein the information comprises a generation of the RAT/mobile network used for the transmission.

The UE 120 may further be configured to, e.g. by means of an indicating unit 1106 and/or the processing unit 1101, indicate or provide the technical details to a user of the UE 120 and/or to an application on the UE 120, where the provided technical details may include the generation of the RAT/mobile network that the service was received on. The indication unit may e.g. be a display of the UE 120.

The UE 120 may further be configured to, e.g. by means of the determining unit 1105 and/or the processing unit 1101, determine based on the obtained information, that the service was received from the non-legitimate device 150.

The UE 120 may further be configured to, e.g. by means of the determining unit 1105 and/or the processing unit 1101, determine that the service has been received from the non-legitimate device 150 when the service was received via a 2G mobile network although later generation mobile networks are expected.

The UE 120 may further be configured to, e.g. by means of the determining unit 1105 and/or the processing unit 1101, determine that the service has been received from the non-legitimate device 150 when the UE 120 uses a newer generation network and the UE 120 switches to a 2G RAT/mobile network for a short period of time and receives the service during the period of time that the UE 120 is connected to the 2G RAT/mobile network.

The UE 120 may further be configured to, e.g. by means of an indicating unit 1106 and/or the processing unit 1101, indicate, e.g. to a user of the UE 120, that the service was received by a non-legitimate device 150.

The UE 120 may further be configured to, e.g. by means of a blocking unit 1103 and/or the processing unit 1101, block a service to be set up from the UE 120 to the non-legitimate device 150.

The UE 120 may further be configured to, e.g. by means of the communication unit 402 and/or a sending unit 410 and/or the processing unit 401, transmit, to a network node 110, information regarding the technical details of the transmission of a service received, wherein the information comprises a generation of the RAT/mobile network used for the transmission.

Those skilled in the art will also appreciate that the blocking unit 1103, the determining unit 1105, the indicating unit 1106 and the obtaining unit 1111 described above may refer to a combination of analog and digital circuits, and/or one or more processors configured with software and/or firmware, e.g. stored in the memory 1107, that when executed by the one or more processors such as the processing unit 1101 as described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

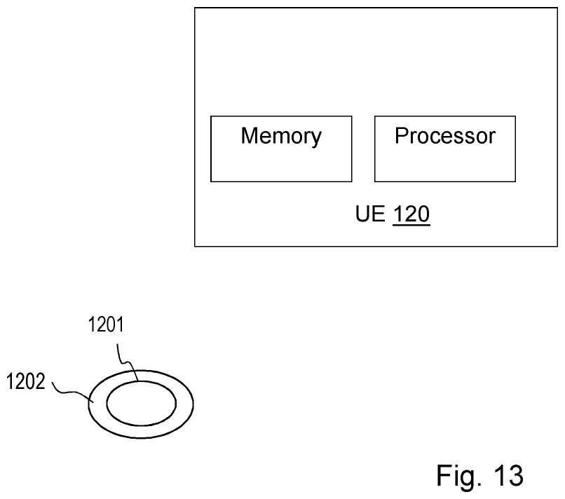

The embodiments herein for detection that the UE 120 has been communicating with a non-legitimate device 150 may be implemented through a respective processor or one or more processors of a processing circuitry in the UE 120 as depicted in FIG. 13, which processing circuitry is configured to perform the method actions according to FIG. 4 and the embodiments described above for the UE 120.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as e.g. a memory stick. The computer program code may furthermore be provided as pure program code on a server and downloaded to the UE 120.

The UE 120 may further comprise a memory 1107. The memory may comprise one or more memory units to be used to store data on, such as the numbers determined to be related to a non-legitimate device, software, patches, system information (SI), configurations, diagnostic data, performance data and/or applications to perform the methods disclosed herein when being executed, and similar.

The method according to the embodiments described herein for the UE 120 may be implemented by means of e.g. a computer program product 1109, 1201 or a computer program, comprising instructions, i.e., software code portions, which, when executed on at least one processor, cause at least one processor to carry out the actions described herein, as performed by the UE 120. The computer program product 1108, 1201 may be stored on a computer-readable storage medium 1108, 1202, e.g. a disc or similar. The computer-readable storage medium 1108, 1202, having stored thereon the computer program, may comprise instructions which, when executed on at least one processor, cause the at least one processor to carry out the actions described herein, as performed by the UE 120. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

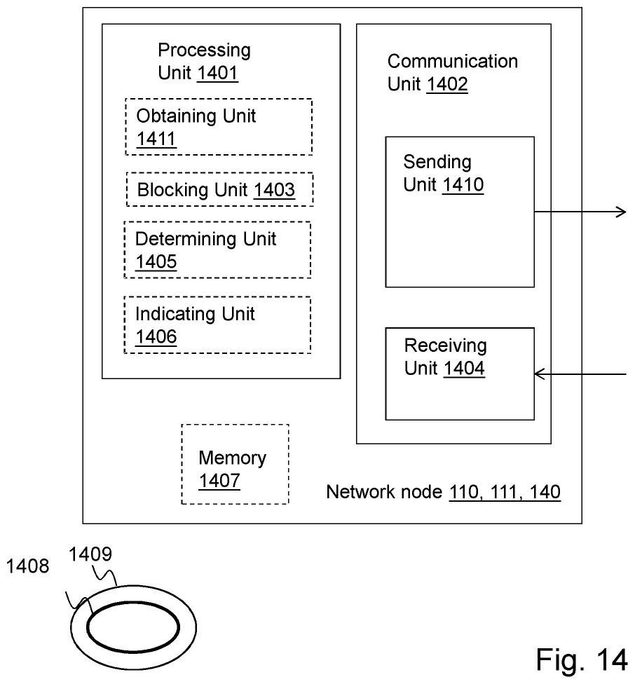

To perform the method actions for detecting that the UE 120 has been communicating with a non-legitimate device 150, described above in relation to FIG. 11, the network node 110, 111, 140 may comprise the following arrangement as depicted in FIG. 14.

The network node 110, 111, 140 may comprise a processing unit 1401 and a communication unit 1402 for communicating with network devices, such as the UE 120 or other network nodes 110, 111, 140. The communication unit 1402 may comprise a sending unit 1410 and a receiving unit 1404.

The network node 110, 111, 140 may be configured to, e.g. by means of the communication unit 1402 and/or an obtaining unit 1411 and/or the processing unit 1401, obtain information regarding technical details of the transmission of a service received by the UE 120, wherein the information comprises a generation of the RAT/mobile network used for the transmission of the service to the UE 120.

The network node 110, 111, 140 may further be configured to, e.g. by means of the determining unit 1405 and/or the processing unit 1401, determine, based on the received information, that the service was received from the non-legitimate device 150, wherein the service is determined to have been received from the non-legitimate device 150 when the technical details do not correspond to the technical details expected for the legitimate network, such as the first domain of the communications network.

The network node 110, 111, 140 may further be configured to, e.g. by means of an indicating unit 1406 and/or the processing unit 1401, indicate that the service was received from the non-legitimate device 150.

The network node 110, 111, 140 may further be configured to, e.g. by means of the determining unit 1405 and/or the processing unit 1401, determine that the service has been received from the non-legitimate device 150 when the information regarding the technical details shows that the service was received via a 2G mobile network although later generation mobile networks are expected.

Those skilled in the art will also appreciate that the blocking unit 1403, the determining unit 1405, the indicating unit 1406 and the obtaining unit 1411 described above may refer to a combination of analog and digital circuits, and/or one or more processors configured with software and/or firmware, e.g. stored in the memory 1407, that when executed by the one or more processors such as the processing unit 1401 as described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein for detecting that the UE 120 has been communicating with a non-legitimate device 150 may be implemented through a respective processor or one or more processors of a processing circuitry in the network node 110, 111, 140 as depicted in FIG. 14, which processing circuitry is configured to perform the method actions according to FIG. 11 and the embodiments described above for the network node 110, 111, 140.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as e.g. a memory stick. The computer program code may furthermore be provided as pure program code on a server and downloaded to the UE 120.

The UE 120 may further comprise a memory 1407. The memory may comprise one or more memory units to be used to store data on, such as the numbers determined to be related to a non-legitimate device, software, patches, system information (SI), configurations, diagnostic data, performance data and/or applications to perform the methods disclosed herein when being executed, and similar.

The method according to the embodiments described herein for the UE 120 may be implemented by means of e.g. a computer program product 1409, 1501 or a computer program, comprising instructions, i.e., software code portions, which, when executed on at least one processor, cause at least one processor to carry out the actions described herein, as performed by the UE 120. The computer program product 1408, 1501 may be stored on a computer-readable storage medium 1408, 1502, e.g. a disc or similar. The computer-readable storage medium 1408, 1502, having stored thereon the computer program, may comprise instructions which, when executed on at least one processor, cause the at least one processor to carry out the actions described herein, as performed by the UE 150. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

When using the word “comprise” or “comprising” it shall be interpreted as non-limiting, i.e. meaning “consist at least of”.

It will now be described in more detail examples of how the above-described technical details could be obtained. In the following, some further parts comprised in the UE will also be described. After that, a description of how said technical details of received services may be obtained by the UE will be provided.

Some examples of internal parts of the UE will now be described.

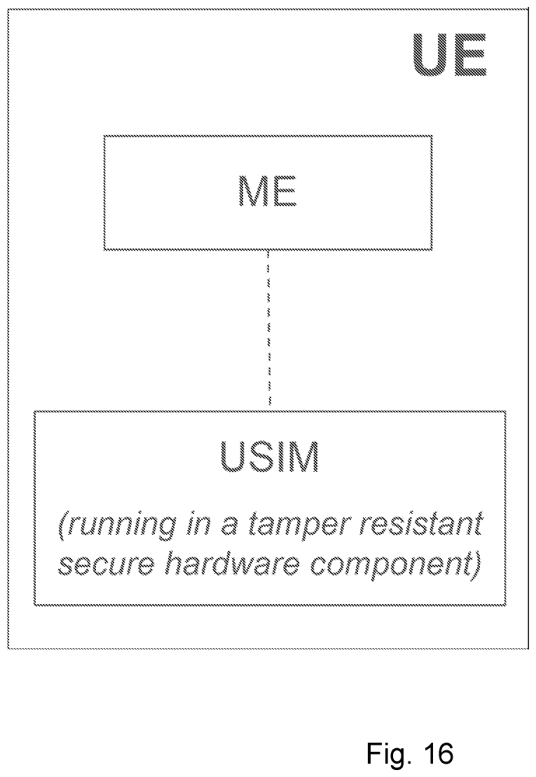

On a high level, the UE 120 comprises two parts, namely a Universal Subscriber Identity Module (USIM) and a Mobile Equipment (ME) as shown in FIG. 16. The USIM part is a special software application that provides various functions like providing identifier and authentication of the user's subscription, security key generations, etc. The USIM runs on a tamper resistant secure hardware component, e.g., a Universal Integrated Circuit Card (UICC). The ME part denotes the wireless device comprising of hardware and software needed to communicate with the network. The ME is popularly known as a mobile phone, or smart phone.

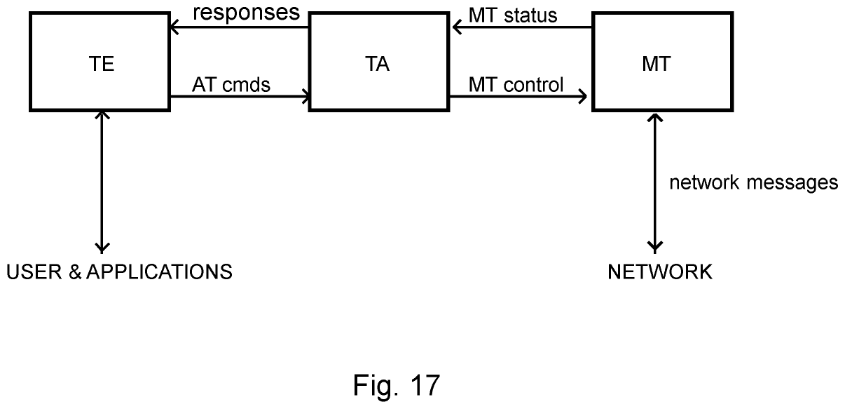

FIG. 17 shows various parts that may be comprised in the ME of FIG. 16, and reference is made to 3GPP TS 27.007 v. 15.3.0. The ME comprised in the UE may further comprises various parts as disclosed in 3GPP TS 27.007 v. 15.3.0. In FIG. 17 the ME comprises a Terminal Equipment (TE), a Terminal Adaption (TA) unit, and a Mobile Termination (MT) unit. The TE may send Attention commands (AT cmds) to the TA. Since the design of the ME is heavily influenced by diverse stakeholders and markets, external and internal interfaces for the ME are not standardized except for a few exceptions. For example, interfaces like TE-User & Applications, MT/TA-TE and MT-TA are not standardized. Exceptions are that the radio (MT-Network), the ME-USIM and AT commands are standardized. Non-standardized interfaces are open to manufacturer specific implementations.

Some examples of technical details of received service will now be described. The user & applications part in FIG. 17 could be for example a service application, an SMS application, a phone call application, an SMS history application, a call history application, or a mobile operating system, such as e.g., Android. In general, the user&application part may be any software or hardware that may obtain and process the technical details of received services. The user & application part may interface with the TE part to obtain the technical details, such as e.g., generation of mobile networks, security algorithm, location, etc., of how the service was delivered. The user & application part may obtain the information from the TE part by requesting it from the TE part, with may also be referred to as the user & application part fetching or requesting the information from the TE. The TE part may push the information to the user & application part. Instead of the user & application part obtaining and processing the technical details from the TE part, it could also be the TE part that provides already processed information to the user & application part. Similarly, the TE part may interface with the MT/TA part, in either a fetch fashion or a push fashion as mentioned previously. One way of interfacing may be using AT commands. For example, the 3GPP TS 27.007 defines a command referred to as “+CREG” command that may be used to obtain information about the mobile network generation, which may also be referred to as the generation of the RAT.

Besides RAT-related information, visibility of encryption information (“the user is informed whether the confidentiality of user data is protected on the radio access link”) is also specified in 3GPP specifications: for 3G in clause 5.5.1 of 3GPP TS 33.102, for 4G in clause 5.2 of 3GPP TS 33.401 and for 5G in clause 5.10.1 of 3GPP TS 33.501 v. 15.2.0. Furthermore, a manufacturer of the UE 120 comprising the TE, the TA and the MT may also provide proprietary AT commands or responses to expose additional technical details of the received service. The parts mentioned above may also be referred to as units.

While the solution has been described with reference to specific exemplifying embodiments, the description is generally only intended to illustrate the inventive concept and should not be taken as limiting the scope of the solution. For example, the terms “User Equipment, UE”, “network node”, “communications network”, “legitimate network”, “non-legitimate device” and “technical details” have been used throughout this disclosure, although any other corresponding entities, functions, and/or parameters could also be used having the features and characteristics described here. The solution is defined by the appended claims.

1. A method performed by a user equipment (UE) in a communications network for detection that the UE has been communicating with a non-legitimate device that impersonates a network node, wherein the method comprises:
obtaining technical detail information regarding technical details of the transmission of a service received by the UE, wherein the technical detail information indicates a Radio Access Technology (RAT) or a mobile network generation; and
providing the technical detail information to a user of the UE and/or to an application on the UE.

2. The method of claim 1, wherein the method further comprises:
determining, based on the obtained technical detail information, that the service was received from the non-legitimate device.

3. The method of claim 2, wherein the service is determined to have been received from the non-legitimate device when the service was received via a second generation (2G) mobile network although a later generation mobile network is expected.

4. The method of claim 2, wherein the service is determined to have been received from the non-legitimate device when the UE uses a third or higher generation network and the UE switches to a second generation (2G) mobile network for a short period of time and receives the service during the period of time that the UE is connected to the 2G network.

5. The method of claim 1, wherein the step of providing further comprises indicating that the service was received from the non-legitimate device.

6. The method of claim 1, wherein the method further comprises:
blocking a service to be set up from the UE to the non-legitimate device.

7. The method of claim 1, wherein the method further comprises:
transmitting, to a network node, an indication that the service was received from a non-legitimate device.

8. A user equipment (UE) in a communications network for detection that the UE has been communicating with a non-legitimate device which impersonates a network node, wherein the UE comprises:
memory; and
processing circuitry coupled to the memory, wherein the UE is configured to:
obtain technical detail information regarding technical details of the transmission of a service received by the UE, wherein the technical detail information indicates a Radio Access Technology (RAT) or a mobile network generation, and
provide the technical detail information to a user of the UE and/or to an application on the UE.

9. The UE of claim 8, wherein the UE is configured to determine, based on the obtained technical detail information, that the service was received from the non-legitimate device.

10. The UE of claim 9, wherein the UE is configured to determine that the service has been received from the non-legitimate device when the service was received via a second generation (2G) mobile network although a later generation mobile network is expected.

11. The UE of claim 9, wherein the UE is configured to determine that the service has been received from the non-legitimate device when the UE uses a third or higher generation network and the UE switches to a second generation (2G) mobile network for a short period of time and receives the service during the period of time that the UE is connected to the 2G network.

12. The UE of claim 9, wherein the UE further is configured to:
indicate, to the user of the UE and/or to the application on the UE, that the service was received from the non-legitimate device.

13. The UE of claim 9, wherein the UE further is configured to:
block a service to be set up from the UE to the non-legitimate device.

14. The UE of claim 9, wherein the UE further is configured to:
transmit, to a network node, information regarding the technical details of the transmission of a service received, wherein the information comprises a generation of the RAT/mobile network used for the transmission.

15. (canceled)

16. (canceled)

17. A method performed by a network node in a communications network for detection that a user equipment (UE) has been communicating with a non-legitimate device which impersonates a network node, wherein the method comprises:
obtaining technical detail information regarding technical details of the transmission of a service received by the UE, wherein the technical detail information indicates a Radio Access Technology (RAT) or a mobile network generation; and
determining, based on the received technical detail information, that the service was received from the non-legitimate device, wherein the service is determined to have been received from the non-legitimate device when the indicated generation does correspond to an expected generation.

18. The method of claim 17, wherein the method further comprises:
indicating that the service was received from the non-legitimate device.

19. The method of claim 17, wherein the service is determined to have been received from the non-legitimate device when the technical detail information shows that the service was received via a second generation (2G) mobile network although a later generation mobile network is expected.

20. A network node in a communications network for detection that a user equipment (UE) has been communicating with a non-legitimate device which impersonates a network node, wherein the network node comprises:
memory; and
processing circuitry coupled to the memory, wherein the network node is configured to:
obtain technical detail information regarding technical details of the transmission of a service received by the UE, wherein the technical detail information indicates a Radio Access Technology (RAT) or a mobile network generation; and
determine, based on the received technical detail information, that the service was received from the non-legitimate device, wherein the service is determined to have been received from the non-legitimate device when the indicated generation does correspond to an expected generation.

21. The network node of claim 20, wherein the network node is further configured to:
indicate that the service was received from the non-legitimate device.

22. The network node of claim 20, wherein the network node is further configured to determine that the service has been received from the non-legitimate device when the technical detail information shows that the service was received via a second generation (2G) mobile network although a later generation mobile network is expected.

23. (canceled)

24. (canceled)
